(19) United States
(12) Patent Application Publication
(10) Pub. No.: US 2016/0111705 A1
(43) Pub. Date: Apr. 21, 2016

(54) Metal-Air Battery with Expandable Anode

(71) Applicant: Sharp Laboratories of America (SLA), Inc., Camas, WA (US)

(72) Inventors: Hidayat Kisdarjono, Vancouver, WA (US); Alexander Bauer, Camas, WA (US); Gregory Stecker, Vancouver, WA (US); Wei Pan, Vancouver, WA (US)

(21) Appl. No.: 14/976,755

(22) Filed: Dec. 21, 2015

Related U.S. Application Data
(63) Continuation-in-part of application No. 14/673,559, filed on Mar. 30, 2015.
Application No. 14/673,559 is a continuation-in-part of application No. 14/473,713, filed on Aug. 29, 2014.
Application No. 14/473,713 is a continuation-in-part of application No. 14/042,264, filed on Sep. 30, 2013.
Application No. 14/042,264 is a continuation-in-part of application No. 13/564,015, filed on Aug. 1, 2012.

(51) Int. Cl. H01M 2/38; H01M 12/02; H01M 12/08

(52) U.S. Cl. CPC H01M 2/38; H01M 12/08; H01M 12/02

(57) ABSTRACT

An air cathode battery is provided with a slurry anode. An anode cavity is interposed between the air cathode interior surfaces, with an anode compartment occupying the anode cavity. The anode compartment has a first wall and a second wall, one or both capable of movement. An anode current collector pouch has walls adjacent to interior surfaces of the anode compartment. A zinc slurry occupies an expandable region in the anode compartment between the anode current collector pouch and the anode compartment wall interior surfaces. The anode current collector pouch first wall and second wall contract towards each other in response to expansion in the volume of zinc slurry. In one aspect, the anode compartment first and second walls expand away from each other in response to expansion in the volume of zinc oxide. A replenishable electrolyte source may be used to provide electrolyte to the anode cavity.

### RELATED APPLICATION

The application is a Continuation-in-part of an application entitled, LARGE-SCALE METAL-AIR BATTERY WITH SLURRY ANODE, invented by Hidayat Kisdarjono, Ser. No. 14/673,559, filed on Mar. 30, 2015, Attorney Docket No. SLA3492;

which is a Continuation-in-Part of an application entitled, AIR CATHODE BATTERY USING ZINC SLURRY ANODE WITH CARBON ADDITIVES, invented by Hidayat Kisdarjono et al., Ser. No. 14/473,713, filed on Aug. 29, 2014, Attorney Docket No. SLA 3415;

which is a Continuation-in-Part of an application entitled, FLOW-THROUGH METAL BATTERY WITH ION EXCHANGE MEMBRANE, invented by Yuhao Lu et al Ser. No. 14/042,264, filed on Sep. 30, 2013, Attorney Docket No. SLA3294. All the above-referenced applications are incorporated herein by reference.

### BACKGROUND OF THE INVENTION

1. Field of the Invention

This invention generally relates to electrochemical cells and, more particularly, to an air cathode battery using a replaceable and expandable zinc slurry anode.

2. Description of the Related Art

Flow-through batteries have been intensively studied and developed for large-scale energy storage due to their long cycle life, flexible design, and high reliability. A battery is an electrochemical device in which ions (e.g. metal-ions, hydroxyl-ions, protons, etc.) commute between the anode and cathode to realize energy storage and conversion. In a conventional battery, all the components including anode materials, cathode materials, separator, electrolyte, and current collectors are packed into a volume-fixed container. Its energy and capacity of are unchangeable as long as the battery is assembled. A flow-through battery consists of current collectors (electrodes) separated by an ion exchange membrane, while its anode and cathode materials are stored in separate storage tanks. The anode and cathode materials are circulated through the flow-through battery in which electrochemical reactions take place to deliver and to store energy. Therefore, the battery capacity and energy are determined by (1) electrode materials (anolyte and catholyte), (2) the concentrations of anolyte and catholyte, and (3) the volumes of anolyte and catholyte storage tanks.

An air battery may be considered to be a flow-through cathode battery where oxygen in the air is continuously passed over a reactive metal electrode to act as a cathode. An electrolyte typically separates the cathode from a metal or a metal compound anode. Zinc is a favored material, and it may be in a solid phase or in a particle form to enable a flow-through anode. However, batteries using a flow-through zinc particle anode suffer from the large amounts of electrolyte required to avoid passivation around zinc particles. Further, the zinc particle anode requires continuous pumping, and the viscosity needed to support pumping results in a low zinc concentration.

It is difficult to realize large-scale batteries, as the slurry needs to have high loading of active material, e.g., zinc, to have high energy density, and the cell needs to contain a large amount of slurry per unit area to have a high capacity/long runtime. However, volume expansion, slurry densification, and drying out that occur as zinc is oxidized place design constraints that limit slurry loading and anode volume/thickness. Currently, there is no large-scale battery with exchangeable anode using slurry anode.

In designing a zinc-air cell, it must be considered that conversion occurs from zinc to zinc oxide, which involves volume expansion and densification. An open system suffers from evaporation, leading to drying out, which stops the electrochemical reaction. Addressing these issues with a cell having an exchangeable anode unit poses safety risks, as the user may come in contact with caustic electrolyte.

FIGS. 1A and 1B are drawings respectively depicting a schematic and a photo representing zinc oxide expansion. FIG. 1A shows a cross-section of a zinc-air cell where zinc/zinc oxide slurry expands in all directions. The expansion creates significant internal pressure that densities the zinc oxide, which can lead to deformation in the anode and cathode. FIG. 1B represents a photo showing spent slurry, where the middle thickness had doubled. In small, commercial button cells, this is remedied, at the cost of performance, by filling only 80% of anode cavity. For cells with a large area, however, this is not an optimal solution.

It would be advantageous if a metal-air cathode battery with a zinc slurry could be designed in such a way as to permit expansion due to conversion to zinc oxide, without degrading electrical performance.

### SUMMARY OF THE INVENTION

Disclosed herein is a large-scale metal-air battery with an exchangeable anode unit having an expandable anode cavity. The expandable anode cavity accommodates slurry expansion during discharge by using a movable/expandable anode current collector. A reservoir provides ionic communication between the air-cathode and exchangeable anode unit, and adaptively supplies electrolyte to the slurry to prevent zinc oxide densification. The compact design enables a high volumetric energy density and can be used in two-sided cell. Safeguards act to eliminate the risk of a user coming in contact with caustic electrolyte.

Accordingly, a method is provided for accommodating slurry expansion in an air cathode battery. The method provides a charged battery with an air cathode, an anode cavity, an anode compartment having a wall, zinc slurry in the anode compartment, an electrolyte, and an ion-permeable separator. When the anode and air cathode are connected to an external load, at least a portion of the zinc slurry is converted into zinc oxide. In response to the conversion to zinc oxide, the anode compartment wall moves. In one aspect, simultaneous with moving the anode compartment wall, replenishment electrolyte is supplied to the anode cavity.

The replenishment electrolyte may be supplied from a gravity-feed reservoir overlying the anode cavity, or a bellows-feed reservoir underlying the anode cavity. Further, electrolyte in the anode cavity may be evacuated in response to the volume of zinc slurry expanding.

Also provided is an air cathode battery with a slurry anode. The battery is made from an air cathode having a first interior surface and a second interior surface. An anode cavity is interposed between the air cathode first interior surface and the second interior surface, with an anode compartment occupying the anode cavity. The anode compartment has a first wall and a second wall, both capable of movement. An anode current collector pouch has a first wall adjacent to an interior surface of the anode compartment first wall, and a second wall adjacent to an interiorsurface of the anode compartment second wall. A zinc slurry occupies an expandable region in the anode compartment between the anode current collector pouch and the anode compartment wall interior surfaces. The anode current collector pouch first wall and second wall contract towards each other in response to expansion in the volume of zinc slurry. In one aspect, the anode compartment first and second walls expand away from each other in response to expansion n the volume of zinc oxide. An ion-permeable electrically insulating first separator is mounted on an exterior surface of the anode compartment first wall, and an ion-permeable electrically insulating second separator is mounted on an exterior surface of the anode compartment second wall. A plenishable electrolyte source provides electrolyte to the anode cavity.

Additional details of the above-described method and an air cathode battery are provided below.

### BRIEF DESCRIPTION OF THE DRAWINGS

FIGS. 1A and 1B are drawings respectively depicting a schematic and a photo representing zinc oxide expansion.

FIGS. 2A and 2B are partial cross-sectional diagrams depicting an air cathode battery with a slurry anode in the process of expansion.

FIGS. 3A through 3C are partial cross-sectional views depicting a first variation of the air cathode battery.

FIGS. 4A through 4C are partial cross-sectional views depicting variations of the electrolyte source.

FIGS. 5A through 5C are partial cross-sectional views depicting a two-sided air cathode battery.

FIGS. 6A and 6B are perspective drawings depicting an anode safety sleeve.

FIG. 7 is a flowchart illustrating method for accommodating slurry expansion an air cathode battery.

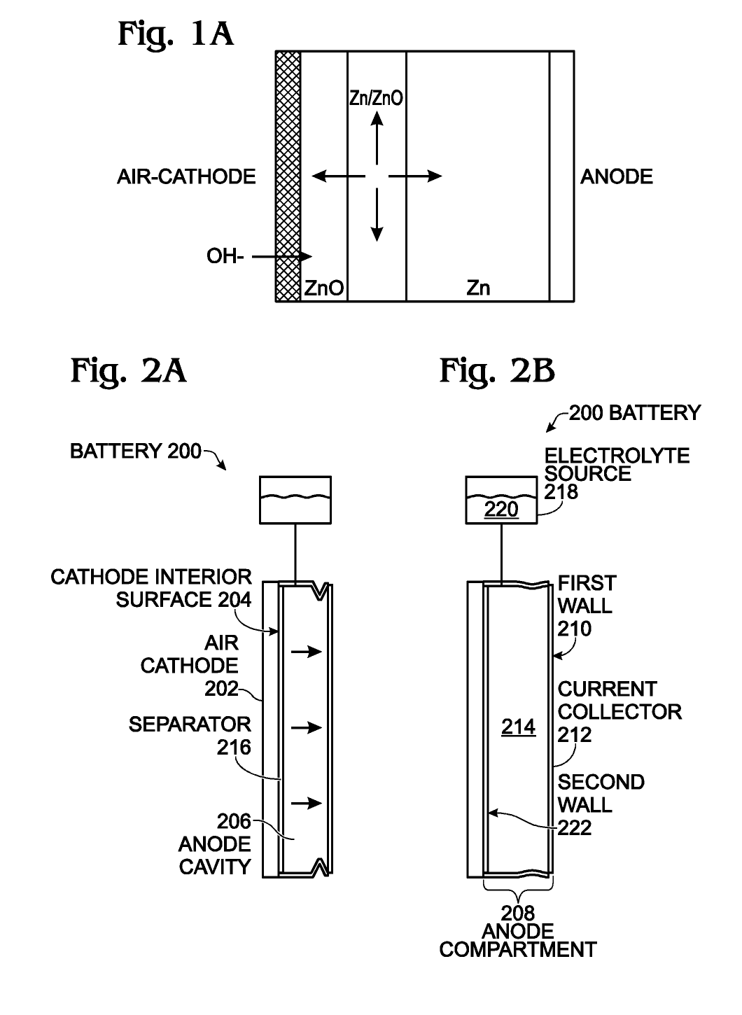

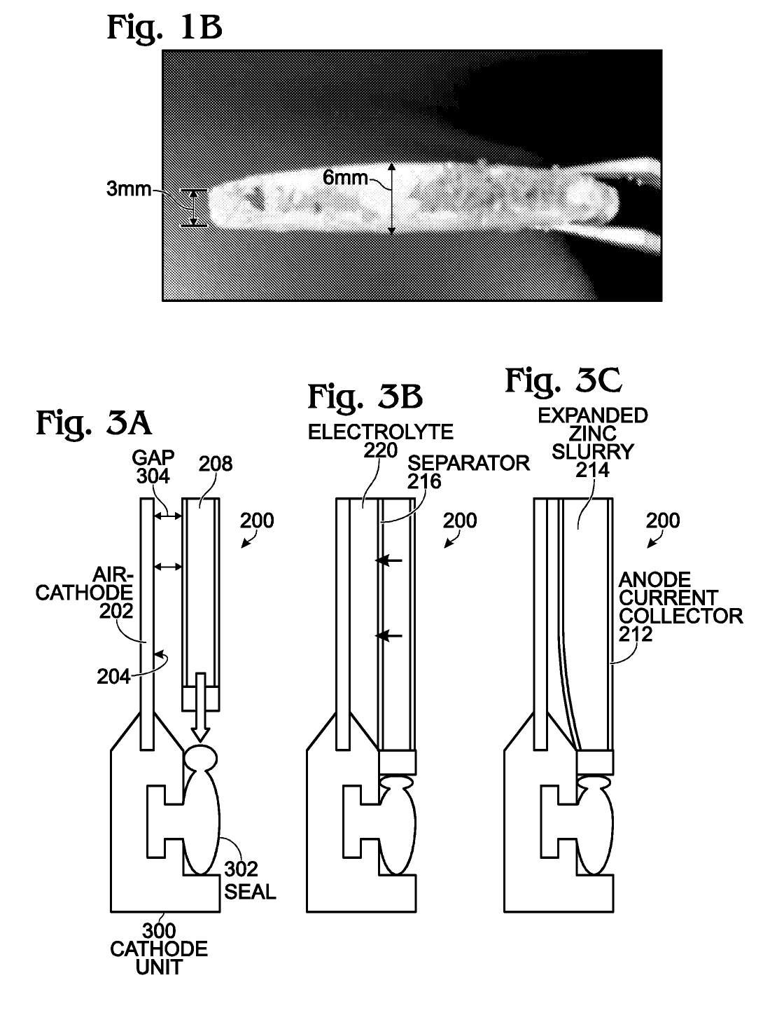

### DETAILED DESCRIPTION

FIGS. 2A and 2B are partial cross-sectional diagrams depicting an air cathode battery with a slurry anode in the process of expansion. The battery 200 comprises an air cathode 202 having an interior surface 204. An anode cavity 206 is adjacent to the air cathode interior surface 204. An anode compartment 208 occupies the anode cavity 206, and has a wall 210 capable of expanding the anode compartment 208. The anode compartment 208 further comprises a current collector 212. A zinc slurry 214 is disposed in the anode compartment 208. An ion-permeable electrically insulating separator 216 is mounted on a wall of the anode compartment, interposed between the anode compartment 208 and the air cathode interior surface 204. A replenishable electrolyte source 218 optionally provides electrolyte 220 to the anode cavity 206.

Typically, the separator 216 has relatively large pores and is permeable to electrolyte. In addition, depending on design, the separator 216 may incorporate an ion exchange membrane (not shown), such as a polymer, to selectively pass ions through relatively small pores. In the case of a zinc slurry for example, such an ion exchange membrane may stop Zn(OH)⁴⁻ or zincate ion from migrating to the cathode.

In one aspect the cathode 202 is integrated with the ion exchange membrane, and is called a membrane-electrode assembly (MEA). As would be well known in the art, and therefore not shown, the cathode 202 comprises a catalyst layer and gas diffusion layer (GDL). The catalyst agent may be platinum particles, embedded in electrically conducting layer of carbon. The GDL may comprise a layer of carbon and platinum particles with some hydrophobic agent such as Teflon™. The GDL allows an in from outside, but keeps water and electrolyte from seeping out, to prevent drying. Typically, the current collector is a highly conductive metal or metal-coated carbon material.

In one aspect, the slurry 214 comprises zinc particles and an alkaline electrolyte. Alternatively, instead or in addition to Zn, the particles may be magnesium (Mg), aluminum (Al), iron (Fe), copper (Cu), or combinations of these metal particles. The slurry 214 may additionally comprise carbon additives and a complexing agent in the alkaline electrolyte. Typically, the zinc particles have an average size (diameter) in the range of 1 micron to 500 microns. The carbon additives may be graphite, carbon fiber, carbon black, or carbon nanoparticles. However, other forms of carbon may also be suitable. Alkaline electrolytes 220 may, for example, be potassium hydroxide (KOH) or sodium hydroxide (NaOH). However, many other alkaline electrolytes are known that could also be table. The complexing agent may be ethylene (amine tetra acetic acid (EDTA), citric acid, or ammonium hydroxide. However, this is not an exhaustive list and other complexing agents would be known by those with skill in the art.

In one aspect as shown, wall 210 (the first wall) capable of movement due to an expansion of zinc slurry volume e anode compartment 208, and the anode compartment further comprises a fixed-position second wall 222. As shown, the anode current collector 212 is formed on the first wall 210, and the separator 216 completely fills a zero-gap space between the anode second wall and the air cathode interior surface 204. As shown, the electrolyte source 218 is gravity fed, but in other variations depicted below, it may be a bellows-feed type.

FIGS. 3A through 3C are partial cross-sectional views depicting variation of the air cathode battery. In FIG. 3A the anode compartment 208 is inserted into cathode unit 30, and any escape of electrolyte 220 and slurry 214 is prevented by seal 302. In this aspect, the first wall 210 is again capable of movement due to an expansion in the volume of zinc slurry, as shown in FIGS. 3B and 3C, but in this case the anode current collector 212 is formed on the fixed-position second wall 222. The separator 216 is formed on the anode first wall 210, and is moveable towards the air cathode interior surface 204. Electrolyte 220, in the gap 304 interposed between the separator 216 and the air cathode interior surface 204, is evacuated as the anode first wall 210 moves. In the interest of clarity, the replenishable electrolyte source is not shown in these figures, but is explained in greater detail below.

As used herein, the evacuation of electrolyte means that some electrolyte is pushed out of the anode cavity, but it should be understood that some electrolyte is soaked up by expanding slurry as well as by the separator. The slurry becomes porous and dry when it expands, and so soaks up the electrolyte in the anode cavity. In effect, the anode cavity acts as an electrolyte reservoir. In one aspect, evacuated slurry is returned to the electrolyte reservoir.

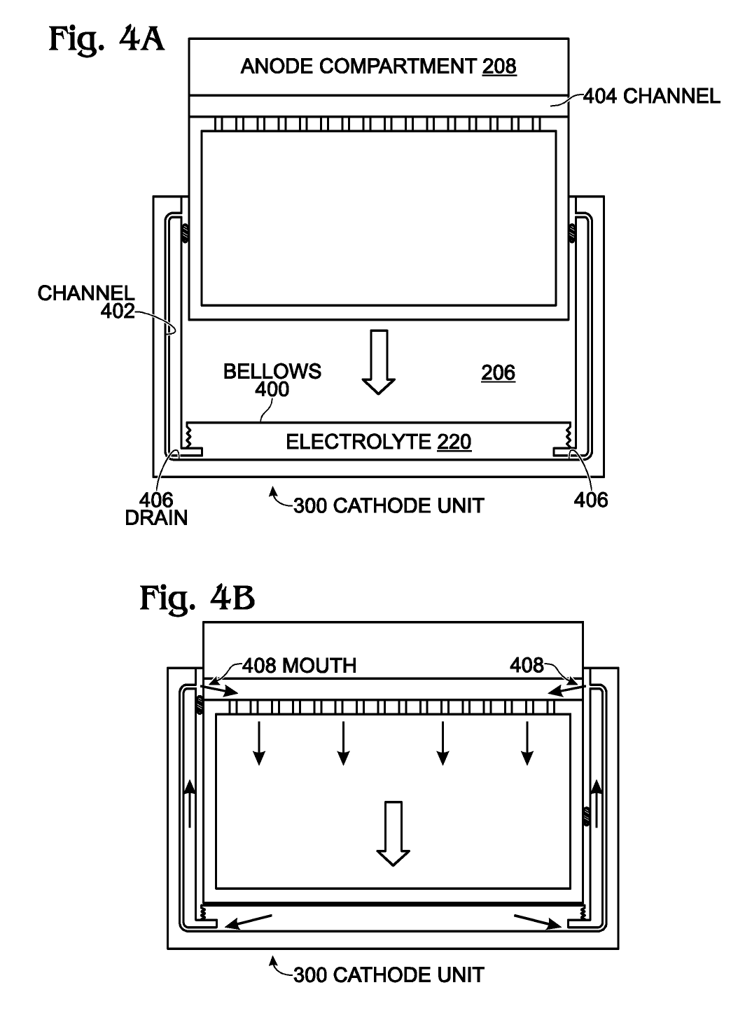

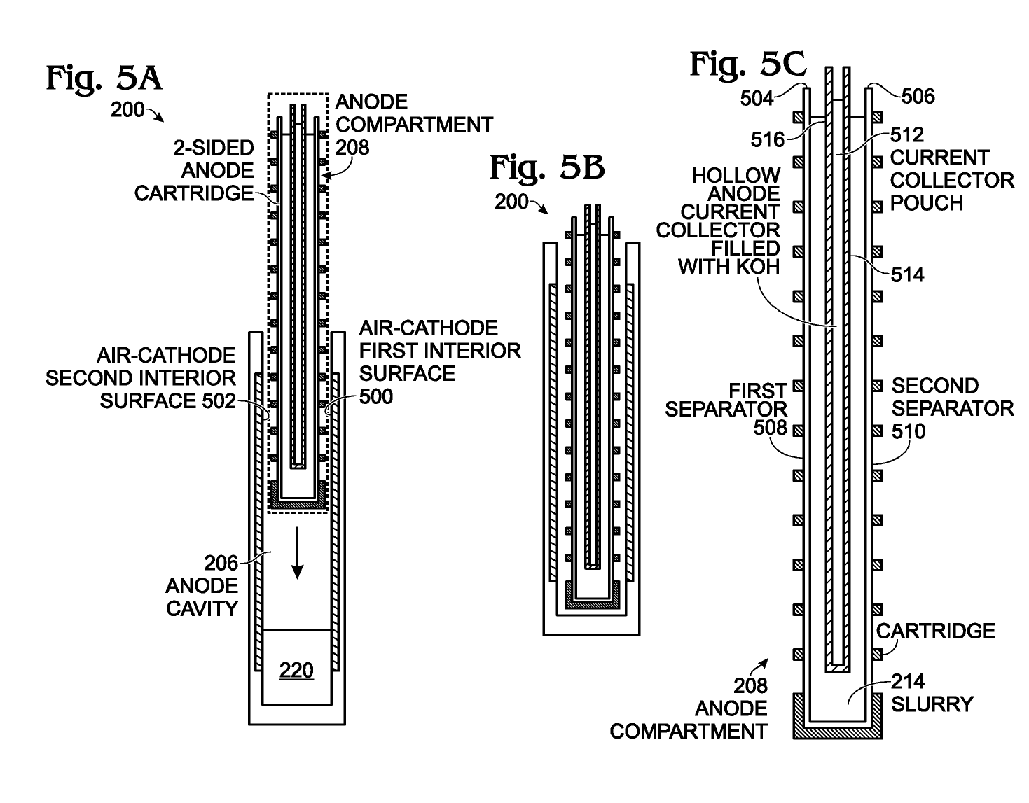

FIGS. 4A through 4C are partial cross-sectional views depicting variations of the electrolyte source. FIGS. 4A and 4B depict a bellows-feed source before and after placement in cathode unit 300. Note: the anode compartment may be as described in FIGS. 2A-2B, FIGS. 3A-3C, or FIGS. 5A-5C. A bellows 400 underlies the anode compartment 208 in the anode cavity 206. A channel, shown as sections 402 and 404, supplies electrolyte 220 from the bellows drain 406 to a mouth 408 of the anode cavity 206. Before insertion of the anode compartment 208, electrolyte is already contained inside bellows 400. To initiate battery operation, the anode compartment 208 is inserted into the cathode unit 300 thereby simultaneously compressing the bellows 400, resulting in electrolyte 220 moving through drain 406 up to mouth 408. Ultimately, electrolyte 220 fills the space between air-cathode and anode cavity 206, providing ionic communication that enables the battery to function.

In FIG. 4C a gravity-feed reservoir 410 overlies the anode compartment 208. A channel 412, or multiple channels as shown, supply electrolyte 220 from a reservoir drain 414 to a mouth 416 of the anode cavity 206.

FIGS. 5A through 5C are partial cross-sectional views depicting a two-sided air cathode battery. FIGS. 5A and 5B depict the mating of an anode compartment with the cathode, and FIG. 5C is a detailed drawing of the anode compartment. The air cathode comprises a first interior surface 500 and a second interior surface 502. The anode cavity 206 is interposed between the air cathode first interior surface 500 and second interior surface 502. The anode compartment 208 comprises a moveable first wall 504 and a moveable second wall 506. A first separator 508 is mounted on an exterior surface of the anode compartment expandable first wall 504 and a second separator 510 is mounted on an exterior surface of the anode compartment expandable second wall 506. Electrolyte 220 fills anode cavity 206 between the air cathode first interior surface 500 and air cathode second interior surface 502.

The anode compartment first wall 504 is moveable towards the air cathode first interior surface 500 when the anode first wall expands, and the anode compartment second wall 506 is moveable towards the air cathode second interior surface 502 when the anode second wall expands. When this expansion occurs, electrolyte 220 in the anode cavity 206 separating the first separator 508 from the air cathode first interior surface 500 may be evacuated as the anode compartment first wall expands 504. Likewise, electrolyte 220 in the anode cavity 206 separating the second separator 510 from the air cathode second interior surface 502 may be evacuated as the anode compartment second wall 506 expands.

In one aspect as shown, the anode current collector is a current collector pouch 512, with a first wall 516 adjacent to an interior surface of the anode compartment first wall 504, and a second wall 514 adjacent to an interior surface of the anode compartment second wall 506. The current collector pouch 512 is immersed in the anode compartment 208 with the zinc slurry 214.

Although not explicitly shown in the interest of clarity, the two-sided air cathode battery may be enabled with the bellows-fed or gravity-fed electrolyte reservoirs described above m the explanation of FIGS. 4A-4C.

One aspect of the battery is the expandable anode that accommodates slurry expansion in an exchangeable anode unit. As shown in FIGS. 3A-3C, a battery cell is comprised of an expandable anode with a small gap between anode and cathode. This variation may be referred to as small-gap cell in which the gap provides the space for volume expansion of slurry. In one aspect, the gap between cathode and anode is 1 to 3 millimeters (mm) and is filled with electrolyte, which supplies electrolyte to slurry, maintaining 20+% (weight) to sustain ionic transport. The cell parameters are chosen such that when nearly all zinc is converted to zinc oxide, electrolyte in gap will have been absorbed into expanding slurry to avoid dripping when anode unit is removed.

FIGS. 2A and 2B describe an expandable anode in a zero-gap cell. A zero-gap cell benefits from simpler cell construction. A minimal amount of electrolyte between the cathode and anode also means higher volumetric energy density. In the zero-gap cell, the slurry has no room to expand against air-cathode (fixed wall). Slurry volume expansion is possible due to a movable anode current collector. The expandable anode current collector can be realized through different ways, (a) accordion-sleeves around current collector plate, (b) stretchable membrane behind a rigid current collector, or (c) pre-folded current collector.

Both aspects described in FIGS. 2A-2B and 3A-3C benefit from the replenishment of electrolyte to maintain ionic communication between the cathode and anode as long as possible. This is achieved with a reservoir (FIGS. 4A-4C) and an exchangeable anode unit. As described in FIGS. 4A and 4B, electrolyte may be stored at the bottom of a cell, inside a leak-proof compressible bladder. As the anode unit is inserted into the cell, it compresses the bladder, sending electrolyte upward through channels inside cell's walls, then along top of anode cartridge toward center of cell and finally downward to fill the gap (anode cavity) between the cathode and anode. The caustic solution is always contained for safety. This method can be called a ‘bottom fill’ approach. Alternatively, as described in FIG. 4C, electrolyte is stored in a reservoir above cell. As the lid compresses the reservoir, due to gravity or controlled pressure, electrolyte enter at the top of the anode unit and electrolyte flows to fill the anode cavity between the cathode and anode.

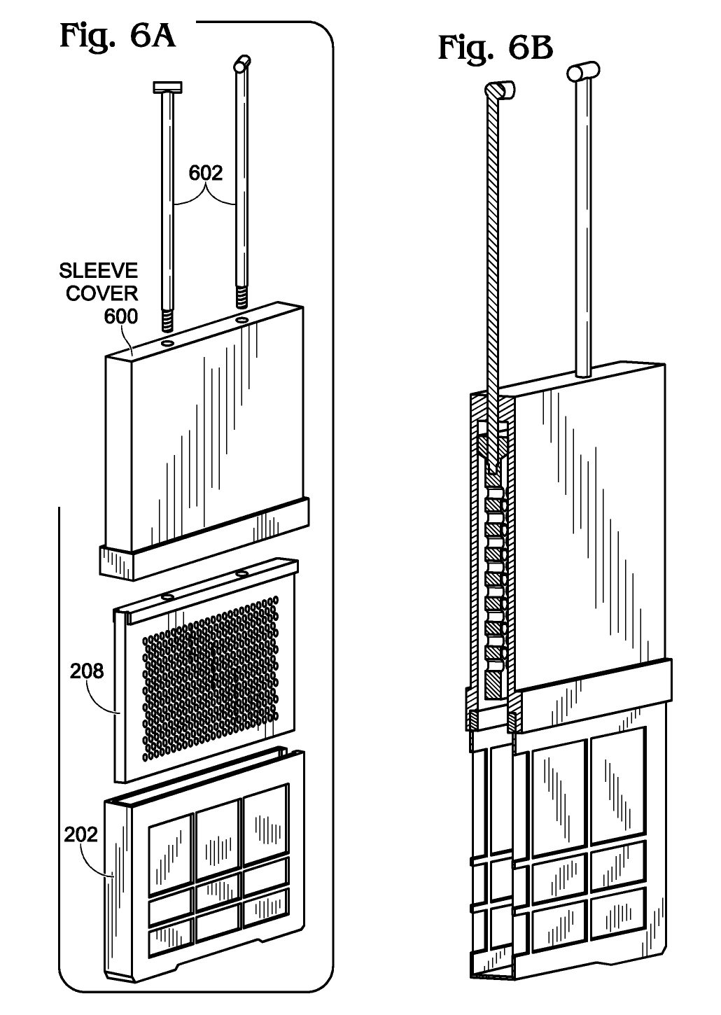

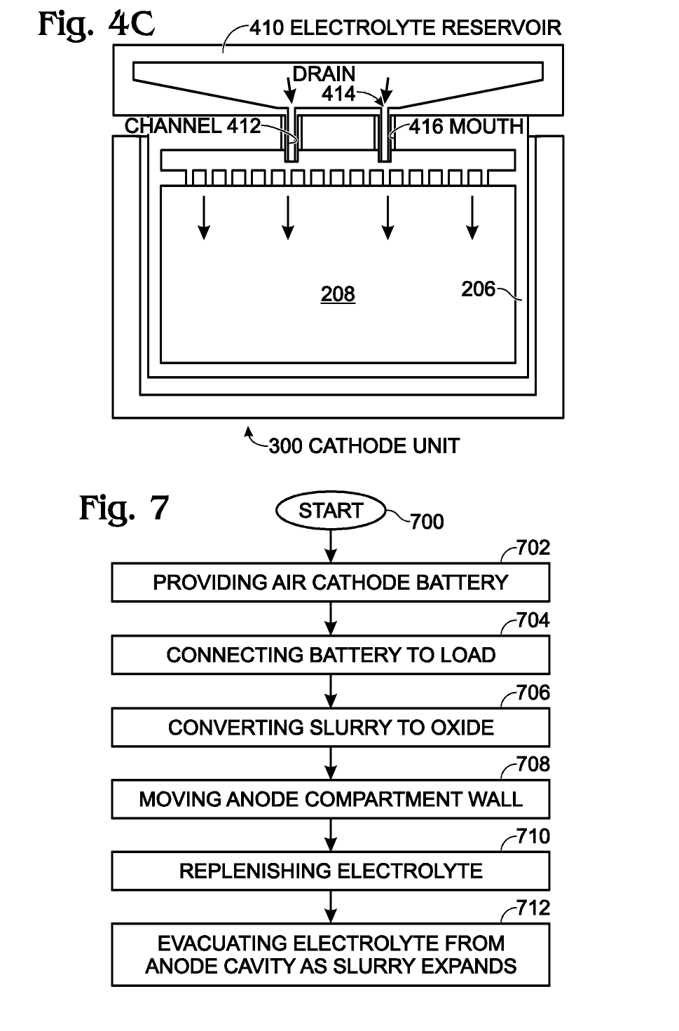

FIGS. 6A and 6B are perspective drawings depicting an anode safety sleeve. To eliminate the risk of a user coming in contact with caustic electrolyte, a sleeve cover 600 may be used to cover the anode compartment 208 as shown. To extract the anode compartment 208 from the air cathode 202, rods 602 are lowered and locked onto anode compartment, and then pulled up, bringing the anode compartment up into sleeve cover 600.

FIGS. 5A-5C describe a two-sided, small-gap cell design with anode current collector pouch. In one variation, as shown in FIG. 5C, the anode current collector is hollow with perforated walls. Electrolyte in the current collector hollow space can permeate through to zinc slurry in the anode compartment to prevent it from drying out. When the slurry expands, anode current collector is designed to collapses under the pressure.

FIG. 7 is a flowchart illustrating method for accommodating slurry expansion an air cathode battery. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps and describes the battery of FIG. 2A through 6B. The method starts at Step 700.

Step 702 provides a charged battery with an air cathode, an anode cavity, an anode compartment having a wall, zinc slurry in the anode compartment, an electrolyte, and an ion-permeable separator. Step 704 connects the anode and air cathode to an external load. Step 706 converts at least a portion of the zinc slurry into zinc oxide. In response to the conversion to zinc oxide, Step 708 moves the anode compartment wall. In one aspect, simultaneous with moving the anode compartment wall in Step 708, Step 710 supplies replenishment electrolyte to the anode cavity. In one aspect, Step 710 supplies electrolyte from a gravity-feed reservoir overlying the anode cavity. Alternatively, Step 710 supplies electrolyte from a bellows-feed reservoir underlying the anode cavity. In another aspect, Step 712 evacuates electrolyte in the anode cavity in response to the volume of zinc slurry expanding.

An air cathode battery with expandable anode has been provided. Examples of materials and configurations have been presented to illustrate the invention. Although only single-sided and two-sided structures have been explicitly disclosed, it should be understood that multi-sided and circular structures are also possible and the invention is not limited to merely these examples. Other variations and embodiments of the invention will occur to those skilled in the art.

We claim:

1. An air cathode battery with a flurry anode, the battery comprising:
an air cathode having an interior surface;
an anode cavity adjacent to the cathode interior surface;
an anode compartment having a wall capable of expanding, and a current collector, the anode compartment occupying the anode cavity;
a zinc slurry in the anode compartment;
an ion-permeable electrically insulating separator mounted on a wall of the anode compartment, interposed between the anode compartment and the air cathode interior surface; and,
a replenishable electrolyte source to provide electrolyte to the anode cavity.

2. The battery of claim 1 wherein the anode compartment comprises a first wall, capable of movement due to an expansion of zinc slurry volume, and a fixed-position second wall, where the anode current collector is formed on the first wall; and,
wherein the separator completely fills a zero-gap space between the anode second wall and the air cathode interior surface.

3. The battery of claim 1 wherein the anode compartment comprises a first wall, capable of movement due to an expansion in the volume of zinc slurry, and a fixed-position second wall, with the anode current collector firmed on the second wall;
wherein the separator is formed on the anode first all, moveable towards the air cathode interior surface; and,
wherein electrolyte, in a gap interposed between the separator and the air cathode interior surface, is evacuated as the anode first wall moves.

4. The battery of claim 1 wherein the replenishable electrolyte source comprises:
a bellows underlying the anode compartment in the anode cavity; and,
a channel to supply electrolyte from the bellows drain to a mouth of the anode cavity.

5. The battery of claim 1 wherein the replenishable electrolyte source comprises:
a gravity-feed reservoir overlying the anode compartment; and,
a channel to supply electrolyte from a reservoir drain to a mouth of the anode cavity.

6. The battery of claim 1 wherein the air cathode comprises a first interior surface and a second interior surface;
wherein the anode cavity is interposed between the air cathode first interior surface and second interior surface;
wherein the anode compartment comprises a moveable first wall and a moveable second wall;
wherein the separator comprises a first separator mounted on an exterior surface of the anode compartment expandable first wall and a second separator mounted on an exterior surface of the anode compartment expandable second wall; and,
wherein electrolyte fills anode cavity between the air cathode first interior surface and air cathode second interior surface.

7. The battery of claim 6 wherein the anode compartment first wall is moveable towards the air cathode first interior surface when the anode first wall expands, and the anode compartment second wall is moveable towards the air cathode second interior surface when the anode second wall expands; and,
wherein electrolyte in a first section of anode cavity separating the first separator from the r cathode first interior surface is evacuated as the anode compartment first wall expands, and electrolyte in a second section of anode cavity separating the second separator from the air cathode second interior surface is evacuated as the anode compartment second wall expands.

8. The battery of claim 7 wherein the anode current collector is a current collector pouch with wall adjacent to an interior surface of the anode compartment first wall, and a second wall adjacent to an interior surface of the anode compartment second wall, and where the current collector pouch is immersed in the anode compartment with the zinc slurry.

9. The battery of claim 8 wherein the replenishable electrolyte source comprises:
a bellows underlying the anode compartment in the anode cavity; and,
a channel to supply electrolyte from a bellows drain to a mouth of the anode cavity.

10. The battery of claim 8 wherein the replenishable electrolyte source comprises:
a gravity-feed reservoir overlying the anode compartment; and,
a channel to supply electrolyte from a reservoir drain to a mouth of the anode cavity.

11. In an air cathode battery, a method for accommodating slurry expansion, the method comprising:
providing a charged battery with an air cathode, an anode cavity, an anode compartment having a wall, zinc slurry in the anode compartment, an electrolyte, and an ion-permeable separator;
connecting the anode and air cathode to an external load;
converting at least a portion of the zinc slurry into zinc oxide; and,
in response to the conversion to zinc oxide, moving the anode compartment wall.

12. The method of claim 11 further comprising:
simultaneous with moving the anode compartment wall, supplying replenishment electrolyte to the anode cavity.

13. The method of claim 12 wherein supplying replenishment electrolyte includes supplying electrolyte from a gravity-feed reservoir overlying the anode cavity.

14. The method of claim 12 wherein supplying replenishment electrolyte includes supplying electrolyte from a bellows-feed reservoir underlying the anode cavity.

15. The method of claim 11 further comprising:
evacuating electrolyte in the anode cavity in response to the volume of zinc slurry expanding.

16. An air cathode battery with a slurry anode, the battery comprising:
an air cathode having a first interior surface and a second interior surface;
an anode cavity interposed between the air cathode first interior surface and the second interior surface;
an anode compartment occupying the anode cavity, the anode compartment having a first wall and a second wall, both capable of movement;
an anode current collector pouch having a first wall adjacent to an interior surface of the anode compartment first wall, and a second wall adjacent to an interior surface of the anode compartment second wall;
a zinc slurry occupying an expandable region in the anode compartment between the anode current collector pouch and the anode compartment wall interior surfaces;
an ion-permeable electrically insulating first separator mounted on an exterior surface of the anode compartment first wall, and an ion-permeable electrically insulating second separator mounted on an exterior surface of the anode compartment second wall; and,
a replenishable electrolyte source to provide electrolyte to the anode cavity.

17. The battery of claim 16 wherein the anode current collector pouch first wall and second wall contract towards each other in response to expansion in the volume of zinc slurry.

18. The battery of claim 16 wherein the replenishable electrolyte source comprises:
a bellows underlying the anode compartment in the anode cavity; and,
a channel to supply electrolyte from a bellows drain to a mouth of the anode cavity.

19. The battery of claim 16 wherein the replenishable electrolyte source comprises:
a gravity-feed reservoir overlying the anode compartment; and,
a channel to supply electrolyte from a reservoir drain to a mouth of the anode cavity.

20. The battery of claim 16 wherein the anode compartment first and second walls expand away from each other response to expansion in the volume of zinc oxide.
